(19) United States
(12) Patent Application Publication
(10) Pub. No.: US 2013/0276147 A1
(43) Pub. Date: Oct. 17, 2013

(54) SEMICONDUCTOR DEVICE, CONFIDENTIAL DATA CONTROL SYSTEM, CONFIDENTIAL DATA CONTROL METHOD

(71) Applicant: LAPIS SEMICONDUCTOR CO., LTD., Yokohama (JP)

(72) Inventor: Koji KOBAYASHI, Yokohama (JP)

(73) Assignee: LAPIS SEMICONDUCTOR CO., LTD., Yokohama (JP)

(21) Appl. No.: 13/862,261

(22) Filed: Apr. 12, 2013

(30) Foreign Application Priority Data
Apr. 13, 2012 (JP) 2012-092377

(51) Int. Cl. G06F 21/60

(52) U.S. Cl. CPC G06F 21/60
USPC 726/30

(57) ABSTRACT

A semiconductor device, confidential data control system and confidential data control method are provided capable of safeguarding confidential data even in cases of unauthorized access to a single storage medium. Capacities of each of confidential data segments, necessary when reading each of confidential data segments from an external memory and an internal memory, are acquired as control data from a register. Then each of the confidential data segments is read based on the acquired control data. It is accordingly rendered difficult to determine data related to the capacity of the confidential data even in cases of unauthorized access (hacking). Moreover, reading of the full confidential data does not occur even if unauthorized access to a single storage medium occurs (either the external memory or the internal memory). Consequently, unauthorized access can be suppressed.

### CROSS-REFERENCE TO RELATED APPLICATION

This application is based on and claims priority under 35 USC 119 from Japanese Patent Application No. 2012-092377 filed on Apr. 13, 2012, the disclosure of which is incorporated by reference herein.

### BACKGROUND

1. Technical Field

The present invention relates to a semiconductor device, a confidential data control system, and a confidential data control method.

2. Related Art

Generally, security enhanced semiconductor devices and data control methods are known that control encryption keys and confidential data such as personal data so as to suppress data leakage. For example, technology disclosed in Japanese Patent Application Laid-Open (JP-A) No. 2011-60136 (Patent Document 1) stores by dividing up data in general and changing locations such as the address in a single memory. Moreover, for example JP-A No. 2009-83211 (Patent Document 2) discloses technology that divides and controls encryption keys in an image forming apparatus that prints encrypted print data.

Generally in related confidential data control systems and control methods, storage is on a single storage medium and only a fixed data capacity is controlled (capable of being handled). However, such control systems and control methods have a high risk of unauthorized access (hacking) of confidential data from a single storage medium and are not technically capable of satisfying requirements of secure organizations.

In the technology of Patent Document 1, application is difficult to situations in which confidential data is held in a particular region, with a concern that confidential data would be easily found if unauthorized access (hacking) occurs.

Moreover, when division and control are performed separately on an apparatus by apparatus basis as in the technology of Patent Document 2, when one considers cases of application to a system LSI, there is a concern that application would be difficult to cases in which complete application to a IC package is desired due to configuration becoming complicated.

### SUMMARY

The present invention is proposed to address the above issues, and an object thereof is to provide a semiconductor device, a confidential data control system and a confidential data control method capable of safeguarding confidential data even in cases in which unauthorized access has been made to a single storage unit.

In order to achieve the above object, a semiconductor device of the present invention includes a reader unit that synthesizes confidential data by reading each of plural confidential data segments from a respective one of plural storage units based on specific control data, wherein a single item of confidential data is divided into a plurality to give the plural confidential data segments and wherein each of the confidential data segments are respectively stored on a different one of the plural storage units according to the specific control data.

A confidential data control system of the present invention includes: plural storage units storing a single item of confidential data that has been divided into plural to give plural confidential data segments that have been respectively stored according to specific control data; and a reader unit that synthesizes confidential data by, when reading the confidential data, reading the confidential data segments from the respective storage units based on the control data.

A confidential data control method of the present invention includes: synthesizing confidential data by reading each of plural confidential data segments from a respective one of plural storage units based on specific control data, wherein a single item of confidential data is divided into a plurality to give the plural confidential data segments and wherein each of the confidential data segments are respectively stored on a different one of the plurality of storage units according to the specific control data.

### BRIEF DESCRIPTION OF THE DRAWINGS

Exemplary embodiments of the present invention will be described in detail based on the following figures, wherein:

FIG. 1 is a circuit diagram illustrating an example of a schematic configuration of a confidential data control system and a semiconductor device for controlling confidential data in a first exemplary embodiment;

FIG. 2 is a schematic diagram illustrating an example of operation to control and read confidential data in a semiconductor device of the first exemplary embodiment;

FIG. 3 is a flow chart illustrating an example of operation to read confidential data in the first exemplary embodiment;

FIG. 4 is a schematic diagram illustrating an example of operation to control and read confidential data in a semiconductor device of a second exemplary embodiment;

FIG. 5 is a schematic diagram illustrating an example of operation to control and read confidential data in a semiconductor device of a third exemplary embodiment;

FIG. 6 is a schematic diagram illustrating an example of operation to control and read confidential data in a semiconductor device of a fourth exemplary embodiment;

FIG. 7 is a flow chart illustrating an example of operation to read confidential data in the fourth exemplary embodiment;

FIG. 8 is a schematic diagram illustrating an example of operation to control and read confidential data in a semiconductor device of a fifth exemplary embodiment;

FIG. 9 is a schematic diagram illustrating an example of operation to control and read confidential data in a semiconductor device of a sixth exemplary embodiment; and

FIG. 10 is a schematic diagram illustrating an example of operation to control and read confidential data in a semiconductor device of a seventh exemplary embodiment.

### DETAILED DESCRIPTION

### First Exemplary Embodiment

Explanation follows regarding a confidential data control system and a semiconductor device for controlling confidential data of the present exemplary embodiment, with reference to the drawings.

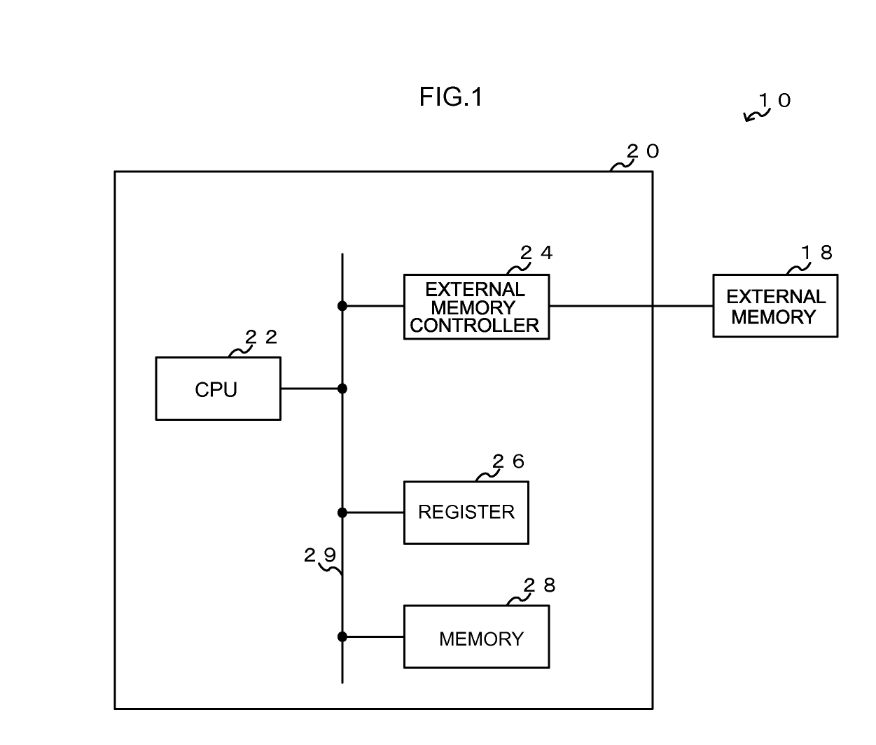

Explanation first follows regarding configuration of a confidential data control system and a semiconductor device for controlling confidential data of the present exemplary embodiment. An example is illustrated in FIG. 1 of a schematic configuration of a confidential data control system and a semiconductor device for controlling confidential data of the present exemplary embodiment. A confidential data control system 10 of the present exemplary embodiment illustrated in FIG. 1 is configured including an external memory 18, and a semiconductor device 20 for controlling confidential data stored on the external memory 18 and on a memory 28.

The semiconductor device 20 includes a CPU 22, an external memory controller 24, a register 26, and the memory 28. The CPU 22, the external memory controller 24, the register 26, and the memory 28 are connected together by a bus 29 so as to be able to transmit and receive signals (data) between each other.

The CPU 22 has a function to control the operation of the semiconductor device 20 overall. In the present exemplary embodiment, the confidential data stored for example on the external memory 18 and the memory 28 is controlled, and reading of confidential data is performed, by the CPU 22 executing software (a program) stored in for example ROM (not shown in the drawings). Note that in the present exemplary embodiment “confidential data” refers to encryption key data employed for decoding encrypted data, and data that must not be leaked to a third party without access rights, such a personal data.

The external memory 18 is a nonvolatile storage medium, such as for example flash memory. The external memory controller 24 of the present exemplary embodiment has a function to control the external memory 18 when the CPU 22 is writing (storing) data on the external memory 18 or reading data from the external memory 18.

The memory (internal memory) 28 of the present exemplary embodiment is a nonvolatile storage medium, such as re-writable flash memory, a single-write enabled ROM, or a mask ROM written to during its manufacture. Note that in the present exemplary embodiment, the memory 28 serves as a main storage medium, and the external memory 18 serves as an ancillary storage medium.

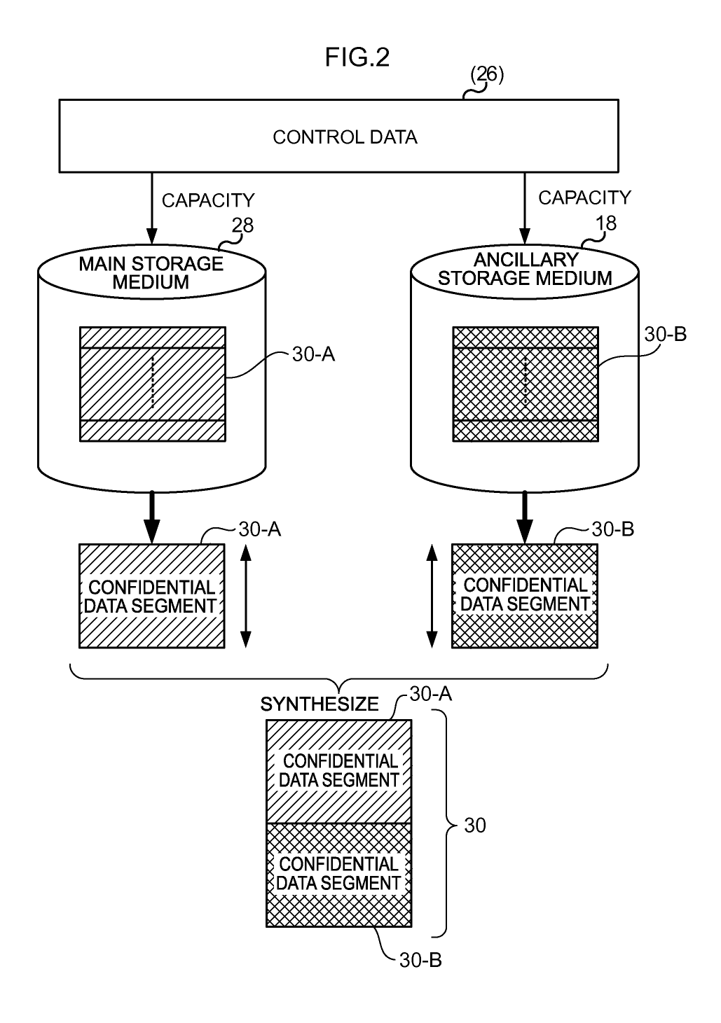

FIG. 2 is a schematic diagram illustrating an example of confidential data control and read operations of the present exemplary embodiment. As illustrated in FIG. 2, in the present exemplary embodiment confidential data 30 is divided into two, and a divided confidential data segment 30-A is stored on the memory 28, this being the main storage medium. A divided confidential data segment 30-B is stored on the external memory 18, this being the ancillary storage medium. Note that the capacity of the confidential data 30 is divided in half in the present exemplary embodiment. Namely, the confidential data segment 30-A and the confidential data segment 30-B have the same capacity. Note that there is no limitation thereto, and the capacity of the confidential data segment 30-A and the confidential data segment 30-B may be made different from each other. Configuration may also be made such that only the capacity of the confidential data segment 30-A for storing in the main storage medium memory 28 is stipulated in advance. The capacity of the confidential data segment 30-B for storing in the ancillary storage medium external memory 18 is then the capacity of the confidential data 30 (total capacity) minus the specific capacity of the confidential data segment 30-A.

The capacity (total capacity) of the confidential data 30, and the capacities of each of the confidential data segments (30-A, 30-B) are stored in advance as control data in the register 26. Note that configuration may be made such that, with respect to the capacity of the confidential data segments, only the capacity of the confidential data segment 30-A stored on the main storage medium memory 28 is stored.

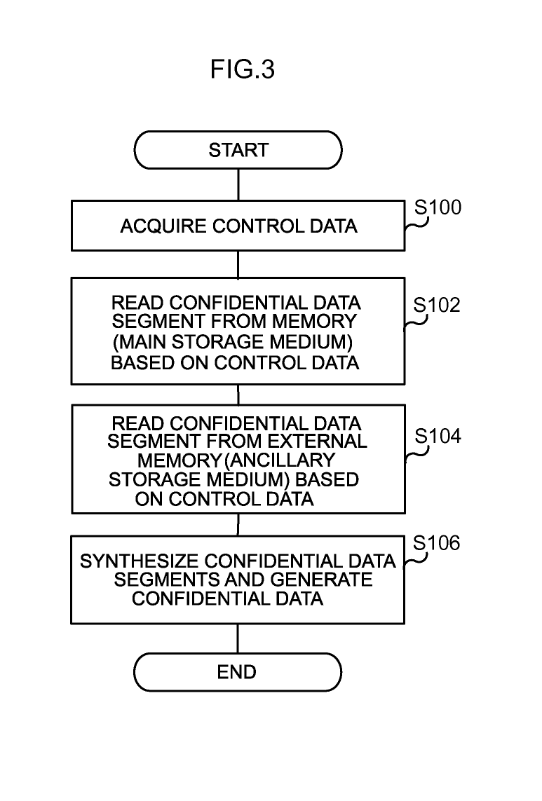

Explanation follows regarding read operation of the confidential data 30 in the semiconductor device 20 of the present exemplary embodiment. FIG. 3 is a flow chart of an example of read operation of the confidential data 30 in the semiconductor device 20 of the present exemplary embodiment. The read operation of the confidential data 30 is executed when an instruction to read the confidential data 30 is input for example from outside of the semiconductor device 20.

At step S100 the control data is acquired from the register 26. Notification in the present exemplary embodiment is by executing software. In the present exemplary embodiment, the capacity of the confidential data 30 and the capacities of the confidential data segments (30-A, 30-B) are acquired as control data, as described above.

At the next step S102, based on the control data, the confidential data segment 30-A is acquired from the memory 28, and at the next step S104, based on the control data, the confidential data segment 30-B is acquired from the external memory 18.

Moreover, at the next step S106, based on the control data, the confidential data segment 30-A and the confidential data segment 30-B are synthesized to generate the confidential data 30, thereby completing the current processing.

Thus in the present exemplary embodiment, control data, such as the capacities of each of the confidential data segments (30-A, 30-B), necessary when reading each of the confidential data segments (30-A, 30-B) from the external memory 18 and the memory 28, are acquired from the register 26, and then each of the confidential data segments (30-A, 30-B) is read based on the acquired control data. The full confidential data 30 is accordingly not read even in cases of unauthorized access to a single storage medium (one or other of the external memory 18 or the memory 28). Moreover, even if data containing each of the confidential data segments (30-A, 30-B) could be read from the storage media (one or other or both of the external memory 18 and the memory 28) by unauthorized access (hacking), reading of the full confidential data 30 can be prevented by the lack of control data. Consequently, data leakage accompanying unauthorized access can be suppressed.

### Second Exemplary Embodiment

The present exemplary embodiment includes configuration and operation substantially the same as that of the confidential data control system 10 and the semiconductor device 20 of the first exemplary embodiment. Substantially the same configuration and operation are indicated by allocation of the same reference numerals and detailed explanation thereof is omitted.

The basic configuration of the confidential data control system and semiconductor device for controlling confidential data of the present exemplary embodiment is substantially the same as that of the first exemplary embodiment (FIG. 1) and so explanation thereof is omitted.

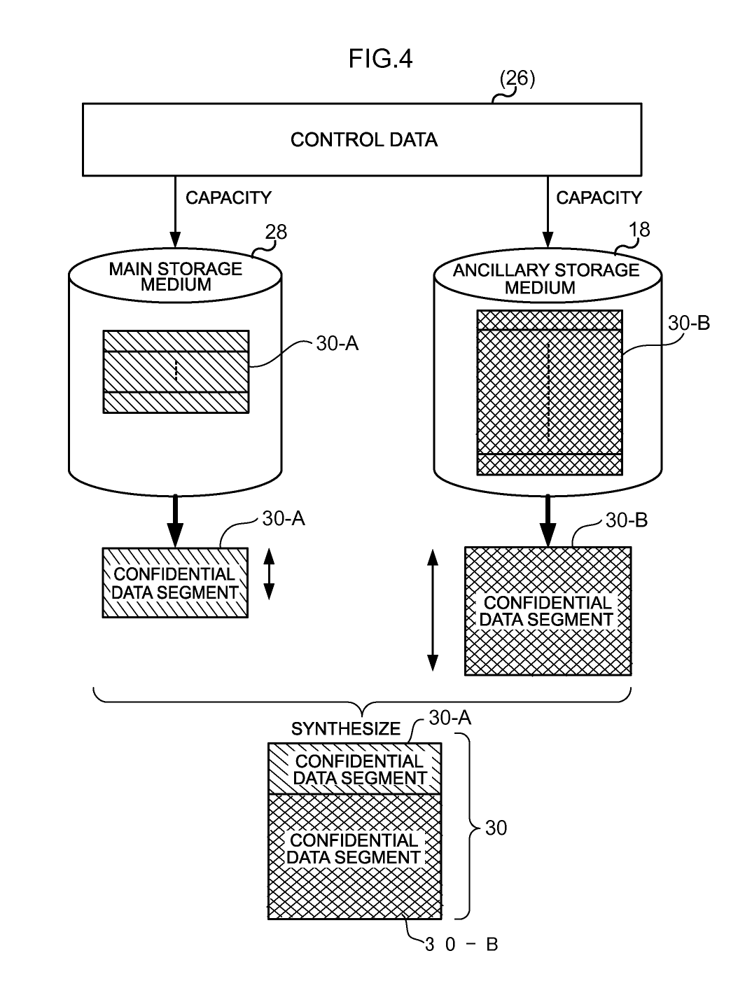

FIG. 4 is a schematic diagram illustrating an example of confidential data control and read operations of the present exemplary embodiment. In the present exemplary embodiment, as illustrated in FIG. 4, similarly to in the first exemplary embodiment, a confidential data segment 30-A is stored on the memory 28, this being the main storage medium and a confidential data segment 30-B is stored on the external memory 18, this being the ancillary storage medium. In the present exemplary embodiment the proportions of the capacities of the confidential data segment 30-A and the confidential data segment 30-B differ from each other, as shown in FIG. 4.

In the present exemplary embodiment, the capacity (total capacity) of the confidential data 30, the capacity of each of the confidential data segments (30-A, 30-B), and the proportions of the confidential data segments are stored in advance as control data in the register 26. Note that the control data stored in the register 26 is not limited thereto, and configuration may be made such that the capacity (total capacity) of the confidential data 30 and the proportions of the confidential data segments are stored in advance, and the capacities of each of the confidential data segments (30-A, 30-B) then computed by software according to the proportions when reading the confidential data 30.

Read operation of the confidential data 30 in the semiconductor device 20 of the present exemplary embodiment is substantially the same as that of the first exemplary embodiment (see FIG. 3). Note that in the present exemplary embodiment too, based on the control data acquired from the register 26 each of the confidential data segments (30-A, 30-B) is read from the memory 28 and the external memory 18, and the confidential data 30 is synthesized, however the control data differs as described above.

Thus in the present exemplary embodiment, the capacities of each of the confidential data segments (30-A, 30-B) and the proportions thereof, necessary when reading each of the confidential data segments (30-A, 30-B) from the external memory 18 and the memory 28, is acquired as control data from the register 26, and then each of the confidential data segments (30-A, 30-B) is read based on the acquired control data. It is accordingly rendered difficult to determine the capacity of data (confidential data segments) employed even in cases of unauthorized access (hacking) In addition to the advantageous effects of the first exemplary embodiment, data leakage can be further suppressed.

### Third Exemplary Embodiment

The present exemplary embodiment includes configuration and operation substantially the same as that of the confidential data control system 10 and the semiconductor device 20 of each of the above exemplary embodiments. Substantially the same configuration and operation is indicated by allocation of the same reference numerals and detailed explanation thereof is omitted. The basic configuration of the confidential data control system and semiconductor device for controlling confidential data of the present exemplary embodiment is substantially the same as that of the first exemplary embodiment (FIG. 1) and so explanation thereof is omitted.

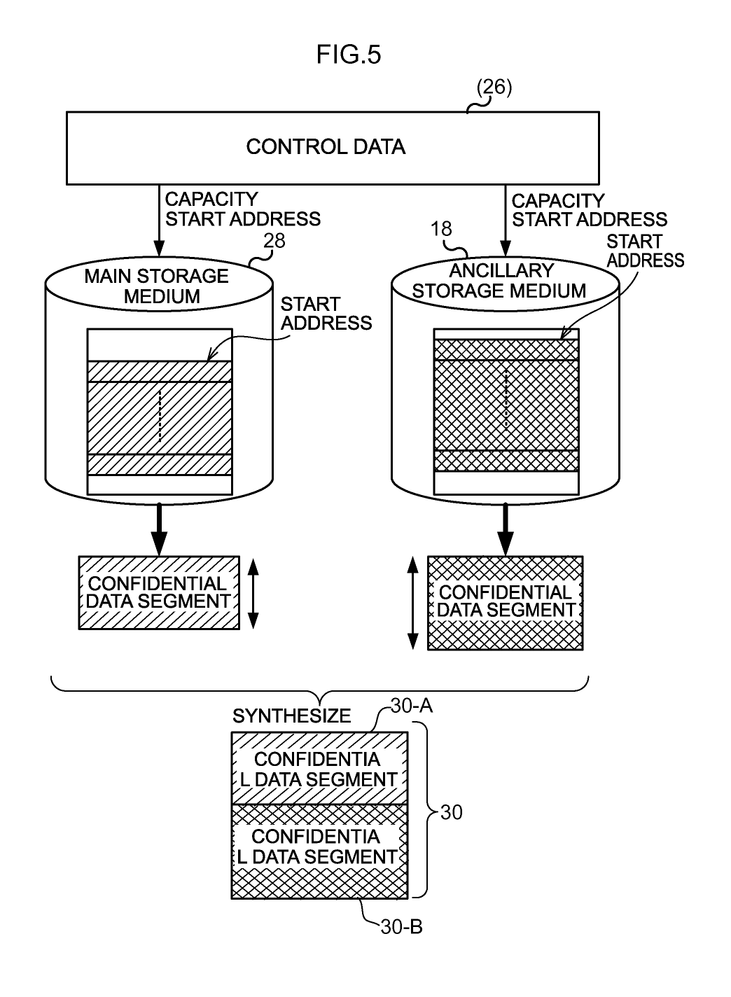

FIG. 5 is a schematic diagram illustrating an example of confidential data control and read operations of the present exemplary embodiment. In the present exemplary embodiment, as illustrated in FIG. 5, similarly to in the first exemplary embodiment, a confidential data segment 30-A is stored on the memory 28, this being the main storage medium, and a confidential data segment 30-B is stored on the external memory 18, this being the ancillary storage medium.

In the present exemplary embodiment, start addresses (addresses indicating the start position in storage regions of each of the storage media) and data capacities of the confidential data segment 30-A and the confidential data segment 30-B are stored as control data in the register 26. Consequently, as illustrated in FIG. 5, the start addresses and the data capacities of the confidential data segment 30-A and the confidential data segment 30-B are variable.

Read operation of the confidential data 30 in the semiconductor device 20 of the present exemplary embodiment is substantially the same as that of the first exemplary embodiment (see FIG. 3). Note that in the present exemplary embodiment too, based on the control data acquired from the register 26 each of the confidential data segments (30-A, 30-B) is read from the memory 28 and the external memory 18, and the confidential data 30 is synthesized, however the control data differs as described above. In the present exemplary embodiment, data of a data capacity based on the control data is read from the start address based on the control data when each of the confidential data segments (30-A, 30-B) is read from each of the storage media (the memory 28 and the external memory 18).

Thus in the present exemplary embodiment, the start addresses and the data capacities of each of the confidential data segments (30-A, 30-B), necessary when reading each of the confidential data segments (30-A, 30-B) from the external memory 18 and the memory 28, are acquired as control data from the register 26, and then each of the confidential data segments (30-A, 30-B) is read based on the acquired control data. It is accordingly rendered difficult to determine the location (position) in the storage medium where the confidential data segments are stored and the stored capacity even in cases of unauthorized access to (hacking of) the storage media (the external memory 18 and the memory 28). In addition to the advantageous effects of the first exemplary embodiment, data leakage can be further suppressed.

### Fourth Exemplary Embodiment

The present exemplary embodiment includes configuration and operation substantially the same as that of the confidential data control system 10 and the semiconductor device 20 of each of the above exemplary embodiments. Substantially the same configuration and operation is indicated by allocation of the same reference numerals and detailed explanation thereof is omitted. The schematic configuration of the confidential data control system and semiconductor device for controlling confidential data of the present exemplary embodiment is substantially the same as that of the first exemplary embodiment (FIG. 1) and so explanation thereof is omitted.

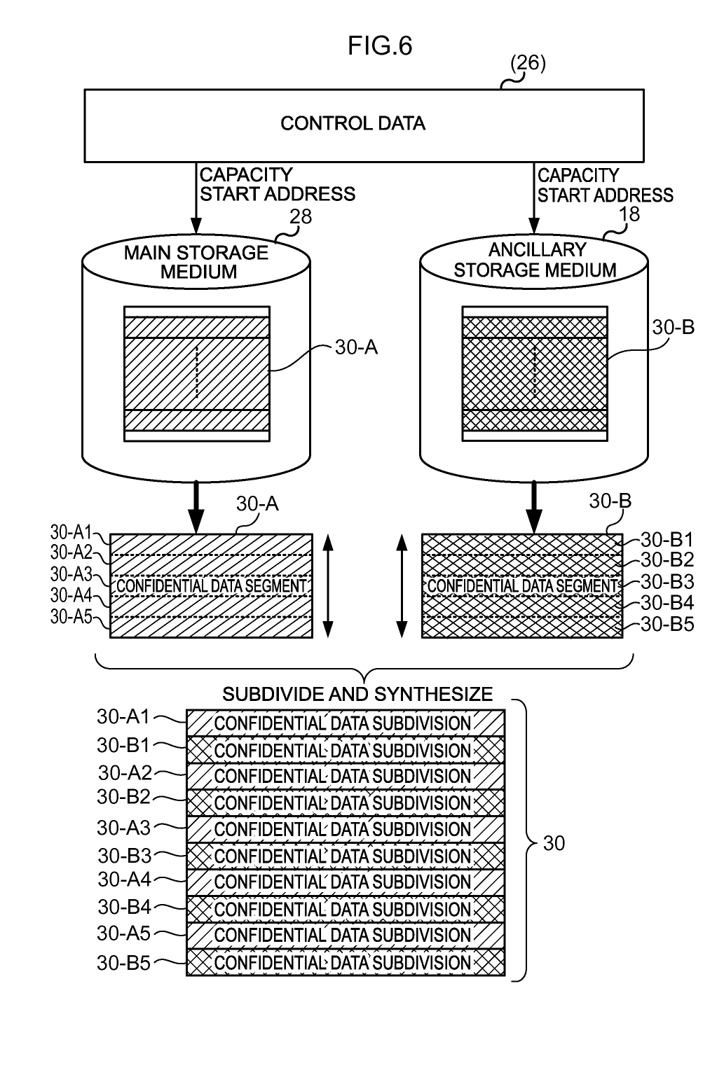

FIG. 6 is a schematic diagram illustrating an example of confidential data control and read operations of the present exemplary embodiment. In the present exemplary embodiment, as illustrated in FIG. 6, similarly to in the first exemplary embodiment, a confidential data segment 30-A is stored on the memory 28, this being the main storage medium, and a confidential data segment 30-B is stored on the external memory 18, this being the ancillary storage medium. Note that when this is performed the present exemplary embodiment differs from the first exemplary embodiment in which the confidential data segments (30-A, 30-B) stored on each of the storage media are simply confidential data segments (30-A, 30-B) of the confidential data 30 divided in half. In the present exemplary embodiment, the confidential data 30 is subdivided in advance into plural (three or more) data subdivisions of capacity according to a specific capacity. Then the subdivided confidential data subdivisions are alternately combined with each other in data sequence to generate the confidential data segment 30-A and the confidential data segment 30-B, and the generated confidential data segments (30-A, 30-B) are stored on each of the storage media (the external memory 18 and the memory 28). Consequently, in the present exemplary embodiment, each of the confidential data segments (30-A, 30-B) is not continuous (successive) data.

In the present exemplary embodiment, start addresses (the addresses indicating the start position in the storage regions of each of the storage media) and data capacities of the confidential data segment 30-A and the confidential data segment 30-B, and the capacity employed when each of the confidential data segments (30-A, 30-B) is subdivided (the specific capacity referred to above) are stored as control data in the register 26. Consequently, similarly to in the third exemplary embodiment, the start addresses and the data capacities of the confidential data segment 30-A and the confidential data segment 30-B are variable.

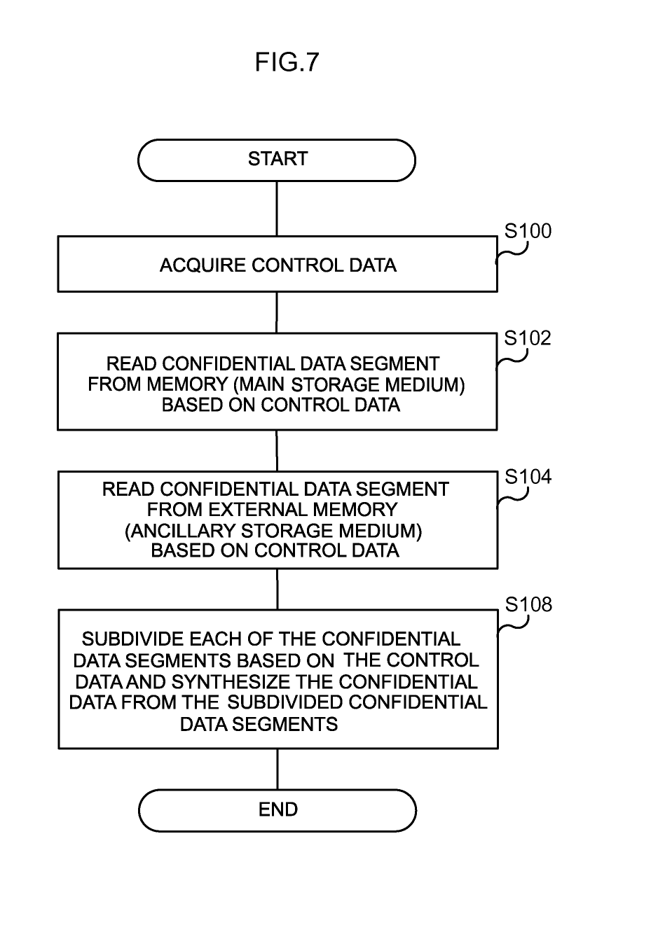

Read operation of the confidential data 30 in the semiconductor device 20 of the present exemplary embodiment is substantially the same as that of the first exemplary embodiment (see FIG. 3), however there is a difference in the way in which the confidential data 30 is synthesized. FIG. 7 is a flow chart illustrating an example of the read operation of the confidential data 30 in the semiconductor device 20 of the present exemplary embodiment.

In the read operation of the confidential data 30 in the semiconductor device 20 of the present exemplary embodiment, a step S108 is provided in place of the step S106 of the read operation of the first exemplary embodiment.

In step S100 to step S104, similarly to in the third exemplary embodiment described above, when reading each of the confidential data segments (30-A, 30-B) from each of the storage media (the memory 28 and the external memory 18), data of a data capacity based on the control data is read from the start addresses based on the control data.

Moreover, in step S108, each of the confidential data segments (30-A, 30-B) are respectively subdivided based on the specific capacity of the control data (see the confidential data subdivisions 30-A1 to 30-A5, and 30-B1 to 30-B5 in FIG. 6). The subdivided confidential data subdivisions (30-A1 to 30-A5, and 30-B1 to 30-B5) are furthermore combined alternately to synthesize the confidential data 30, and the current processing is ended.

Thus in the present exemplary embodiment, the start addresses and the data capacities of each of the confidential data segments (30-A, 30-B), necessary when reading each of the confidential data segments (30-A, 30-B) from the external memory 18 and the memory 28, are acquired as control data from the register 26, and then each of the confidential data segments (30-A, 30-B) is read based on the acquired control data. The specific capacity for subdividing each of the confidential data segments (30-A, 30-B) is also acquired as control data from the register 26, and each of the confidential data segments (30-A, 30-B) is subdivided based on the acquired control data, and the confidential data 30 is synthesized by alternate combination thereof. It is accordingly rendered difficult to determine the confidential data generation method as well as the location (position) in the storage medium where the confidential data segments are stored and the stored capacity even in cases of unauthorized access to (hacking of) the storage media (the external memory 18 and the memory 28). In addition to the advantageous effects of the first exemplary embodiment, data leakage can be further suppressed.

### Fifth Exemplary Embodiment

The present exemplary embodiment includes configuration and operation substantially the same as that of the confidential data control system 10 and the semiconductor device 20 of each of the above exemplary embodiments. Substantially the same configuration and operation is indicated by allocation of the same reference numerals and detailed explanation thereof is omitted. The schematic configuration of the confidential data control system and semiconductor device for controlling confidential data of the present exemplary embodiment is substantially the same as that of the first exemplary embodiment (FIG. 1) and so explanation thereof is omitted.

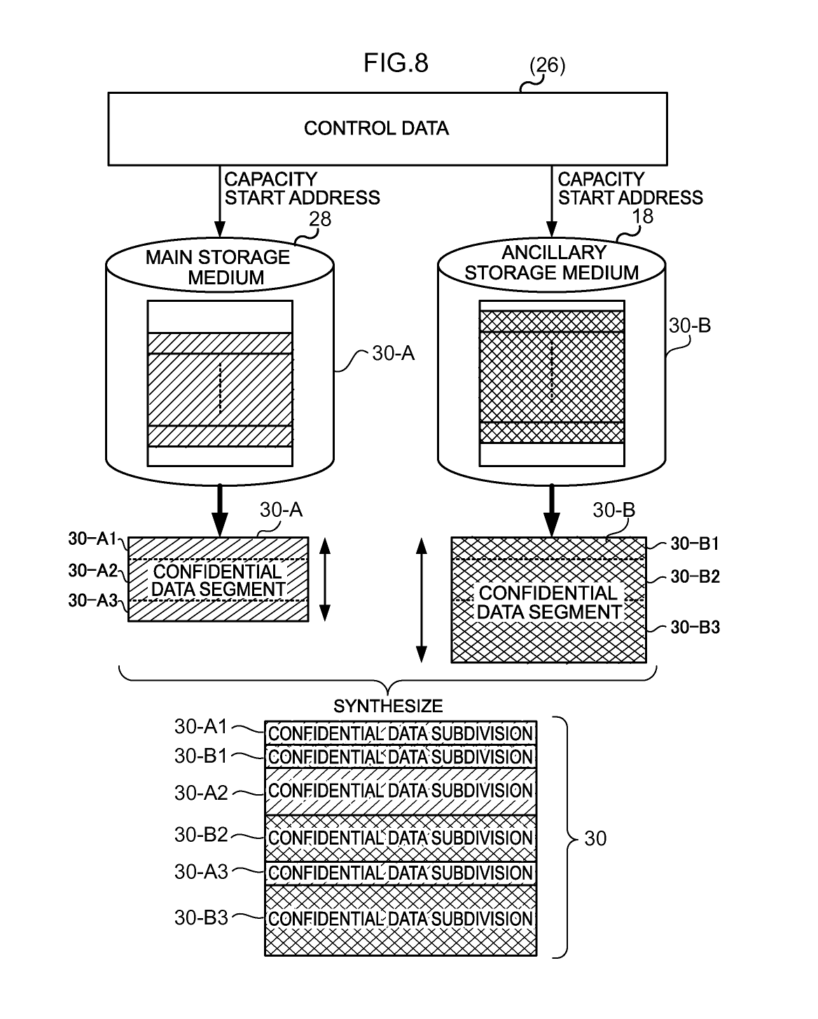

FIG. 8 is a schematic diagram illustrating an example of confidential data control and read operations of the present exemplary embodiment. In the present exemplary embodiment, as illustrated in FIG. 8, similarly to in the first exemplary embodiment, a confidential data segment 30-A is stored on the memory 28, this being the main storage medium, and a confidential data segment 30-B is stored on the external memory 18, this being the ancillary storage medium. Similarly to in the fourth exemplary embodiment, the confidential data 30 is subdivided in advance into a given number of individual data subdivisions (also of a given data capacity) according to a specific capacity. Then the subdivided confidential data subdivisions are alternately combined with each other in data sequence to generate the confidential data segment 30-A and the confidential data segment 30-B, and the generated confidential data segments (30-A, 30-B) are stored on the storage media (the external memory 18 and the memory 28. Note that although the number of subdivisions of the confidential data segment 30-A and the number of subdivisions of the confidential data segment 30-B are both three in FIG. 8 there is no limitation thereto, and another number may be employed, and the number of subdivisions may differ between the two confidential data segments.

In the present exemplary embodiment, start addresses, data capacities of the confidential data segment 30-A and the confidential data segment 30-B, and the number of subdivisions and the subdivision capacities (the capacities of the subdivided data subdivisions) are stored as control data in the register 26.

Read operation of the confidential data 30 in the semiconductor device 20 of the present exemplary embodiment is substantially the same as that of the fourth exemplary embodiment (see FIG. 7). Note that in the present exemplary embodiment, at step S106, the confidential data segments (30-A, 30-B) are each subdivided (see the confidential data subdivisions 30-A1 to 30-A3, and 30-B1 to 30-B3 of FIG. 8) based on the number of subdivisions and the subdivision capacities acquired as control data. The subdivided respective confidential data subdivisions (30-A1 to 30-A3, and 30-B1 to 30-B3) are furthermore combined alternately to synthesize the confidential data 30, thereby ending the current processing.

Thus in the present exemplary embodiment, the start addresses and the data capacities of each of the confidential data segments (30-A, 30-B), necessary when reading each of the confidential data segments (30-A, 30-B) from the external memory 18 and the memory 28, are acquired as control data from the register 26, and then each of the confidential data segments (30-A, 30-B) is read based on the acquired control data. The number of subdivisions and the subdivision capacities for subdividing each of the confidential data segments (30-A, 30-B) is also acquired as control data from the register 26, and based on the acquired control data, each of the confidential data segments (30-A, 30-B) is subdivided, and the confidential data 30 is synthesized by alternate combination thereof. It is accordingly rendered difficult to determine the confidential data generation method as well as the location (position) in the storage medium where the confidential data segments are stored and the stored capacity even in cases of unauthorized access to (hacking of) the storage media (the external memory 18 and the memory 28). In addition to the advantageous effects of the first exemplary embodiment, data leakage can be further suppressed.

### Sixth Exemplary Embodiment

The present exemplary embodiment includes configuration and operation substantially the same as that of the confidential data control system 10 and the semiconductor device 20 of each of the above exemplary embodiments. Substantially the same configuration and operation is indicated by allocation of the same reference numerals and detailed explanation thereof is omitted. The schematic configuration of the confidential data control system and semiconductor device for controlling confidential data of the present exemplary embodiment is substantially the same as that of the first exemplary embodiment (FIG. 1) and so explanation thereof is omitted.

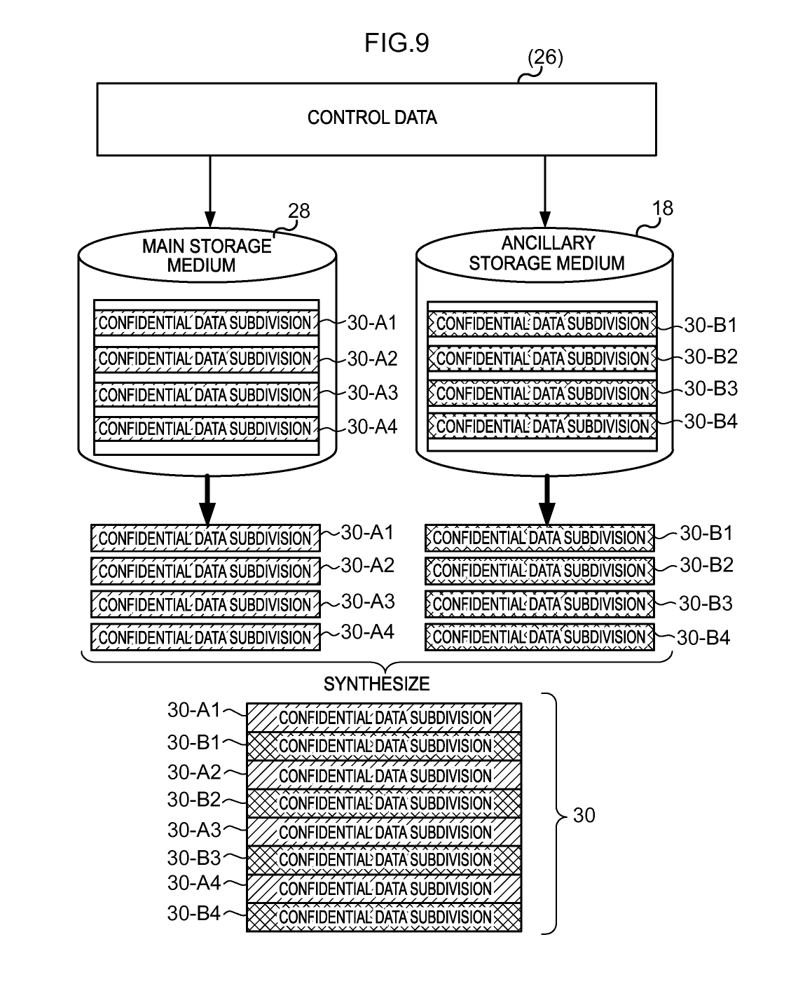

FIG. 9 is a schematic diagram illustrating an example of confidential data control and read operations of the present exemplary embodiment. In the present exemplary embodiment, as illustrated in FIG. 9, similarly to in the first exemplary embodiment, a confidential data segment 30-A is stored on the memory 28, this being the main storage medium, and a confidential data segment 30-B is stored on the external memory 18, this being the ancillary storage medium. Similarly to in the fourth exemplary embodiment, the confidential data 30 is subdivided in advance into a given number (fixed value) of individual data subdivisions (eight in FIG. 9) (the data capacity is also a given fixed value) according to a specific capacity. Then the subdivided confidential data subdivisions are alternately combined with each other in data sequence, configuring the confidential data segment 30-A (see the confidential data subdivisions 30-A1 to 30-A4 in FIG. 9) and the confidential data segment 30-B (see the confidential data subdivisions 30-B1 to 30-B4 in FIG. 9).

In the present exemplary embodiment, when storing the confidential data segments (30-A, 30-B) in each of the storage media (the external memory 18 and the memory 28), the storage position of the confidential data subdivisions (30-A1 to 30-A4, and 30-B1 to 30-B4) in the storage regions of each of the storage media is a given position. Note that in such cases, as illustrated in FIG. 9, each of the confidential data subdivisions (30-A1 to 30-A4, and 30-B1 to 30-B4) is preferably stored with separations therebetween instead of being stored successively (with successive addresses).

In the present exemplary embodiment, start addresses, data capacities, and the number of subdivisions and the subdivision capacities (the capacities of the subdivided data segments) of the confidential data subdivisions (30-A1 to 30-A4) and the confidential data subdivisions (30-B1 to 30-B4) are stored as control data in the register 26.

Read operation of the confidential data 30 in the semiconductor device 20 of the present exemplary embodiment is substantially the same as that of the first exemplary embodiment (see FIG. 3.). Note that in the present exemplary embodiment, at step S102, when acquiring the confidential data segment 30-A from the memory 28 based on the control data, each of the confidential data subdivisions (30-A1 to 30-A4) is read based on the acquired start position. Similarly, at step S104, when acquiring the confidential data segment 30-B from the external memory 18 based on the control data, each of the confidential data subdivisions (30-B1 to 30-B4) are read based on the acquired start position.

Moreover, when synthesizing the confidential data segments 30-A, 30-B and generating the confidential data 30 at step S106, the read confidential data subdivisions (30-A1 to 30-A4, and 30-B1 to 30-B4) are alternately combined with each other to generate the confidential data 30, and the current processing is ended.

Thus in the present exemplary embodiment, the start addresses and the data capacities of each of the confidential data subdivisions (30-A1 to 30-A4, and 30-B1 to 30-B4), necessary when reading each of the confidential data segments (30-A, 30-B) from the external memory 18 and the memory 28, are acquired as control data from the register 26, and then each of the confidential data subdivisions (30-A1 to 30-A4, and 30-B1 to 30-B4) is read based on the acquired control data. The confidential data 30 is also synthesized by alternately combining each of the confidential data subdivisions (30-A1 to 30-A4, and 30-B1 to 30-B4). It is accordingly rendered difficult to determine the confidential data generation method as well as the location (position) in the storage medium where the confidential data segments are stored and the stored capacity even in cases of unauthorized access to (hacking of) the storage media (the external memory 18 and the memory 28). In addition to the advantageous effects of the first exemplary embodiment, data leakage can be further suppressed.

### Seventh Exemplary Embodiment

The present exemplary embodiment includes configuration and operation substantially the same as that of the confidential data control system 10 and the semiconductor device 20 of each of the above exemplary embodiments. Substantially the same configuration and operation is indicated by allocation of the same reference numerals and detailed explanation thereof is omitted. The schematic configuration of the confidential data control system and semiconductor device for controlling confidential data of the present exemplary embodiment is substantially the same as that of the first exemplary embodiment (FIG. 1) and so explanation thereof is omitted.

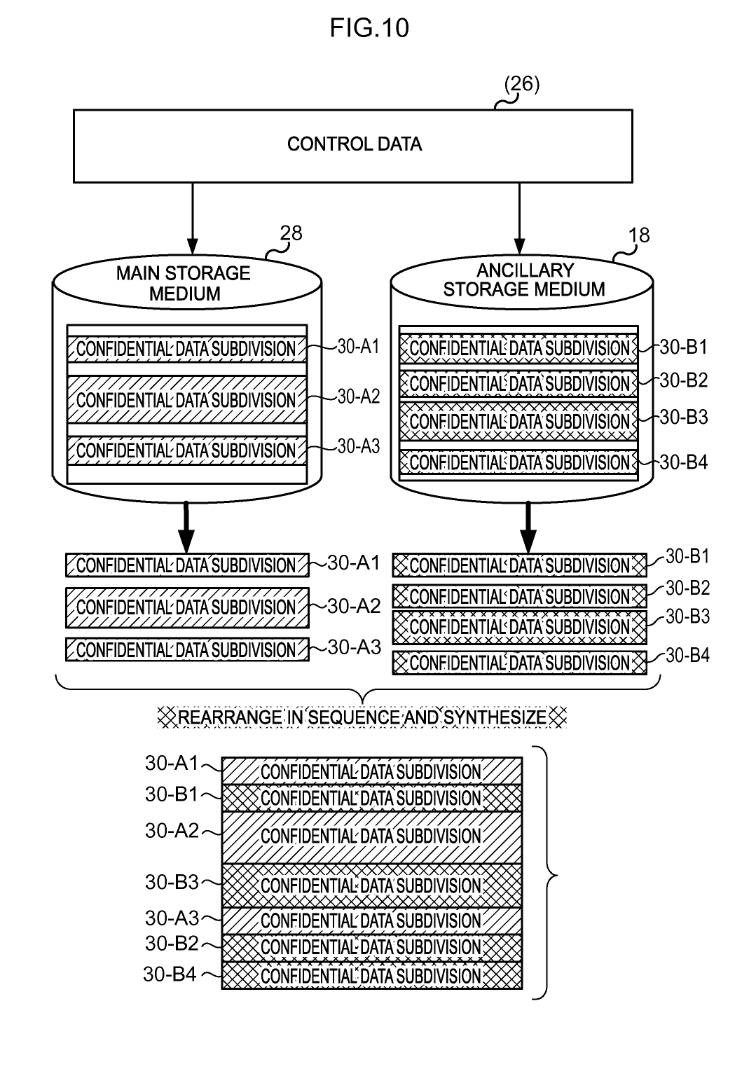

FIG. 10 is a schematic diagram illustrating an example of confidential data control and read operations of the present exemplary embodiment. In the present exemplary embodiment, as illustrated in FIG. 10, similarly to in the first exemplary embodiment, a divided confidential data segment 30-A is stored on the memory 28, this being the main storage medium, and a confidential data segment 30-B is stored on the external memory 18, this being the ancillary storage medium. Similarly to in the sixth exemplary embodiment, the confidential data 30 is subdivided in advance into a given number (variable value) of individual data subdivisions (7 individual subdivisions in FIG. 10) (the data capacity is also a given variable value) according to a specific capacity. Then the subdivided confidential data subdivisions are alternately combined with each other in data sequence to configure the confidential data segment 30-A (see the confidential data subdivisions 30-A1 to 30-A3 in FIG. 10) and the confidential data segment 30-B (see the confidential data subdivisions 30-B1 to 30-B4 in FIG. 10).

In the present exemplary embodiment, when storing the confidential data segments (30-A, 30-B) in each of the storage media (the external memory 18 and the memory 28), similarly to in the sixth exemplary embodiment, the storage position of the confidential data subdivisions (30-A1 to 30-A3, and 30-B1 to 30-B4) in the storage regions of each of the storage media is a given position. Note that in such cases, as illustrated in FIG. 10, each of the confidential data subdivisions (30-A1 to 30-A3, and 30-B1 to 30-B4) may be stored with separations therebetween instead of being stored successively (with successive addresses).

In the present exemplary embodiment, start addresses, data capacities, and the number of subdivisions of the confidential data subdivisions (30-A1 to 30-A3) and the confidential data segments (30-B1 to 30-B4) and the subdivision capacities (the capacity of each of the confidential data subdivisions (30-A1 to 30-A3, and 30-B1 to 30-B4)) are stored in combination sequence as control data in the register 26.

Read operation of the confidential data 30 in the semiconductor device 20 of the present exemplary embodiment is substantially the same as that of the sixth exemplary embodiment. Note that in the present exemplary embodiment, when synthesizing the confidential data segments 30-A, 30-B and generating the confidential data 30 at step S106, the read confidential data subdivisions (30-A1 to 30-A3, and 30-B1 to 30-B4) are combined with each other based on the combination sequence acquired as control data to generate the confidential data 30, and the current processing is ended.

Thus in the present exemplary embodiment, the start addresses and the data capacities of each of the confidential data subdivisions (30-A1 to 30-A3, and 30-B1 to 30-B4), necessary when reading each of the confidential data segments (30-A, 30-B) from the external memory 18 and the memory 28, are acquired as control data from the register 26, and then each of the confidential data subdivisions (30-A1 to 30-A3, and 30-B1 to 30-B4) is read based on the acquired control data. The confidential data 30 is also synthesized by combining each of the confidential data subdivisions (30-A1 to 30-A3, and 30-B1 to 30-B4) based on the combination sequence acquired as control data. It is accordingly rendered even more difficult to determine the confidential data generation method as well as the location (position) in the storage medium where the confidential data segments are stored and the stored capacity even in cases of unauthorized access to (hacking of) the storage media (the external memory 18 and the memory 28). In addition to the advantageous effects of the first exemplary embodiment, data leakage can be further suppressed.

Note that although in each of the above exemplary embodiments the confidential data 30 is divided into the confidential data segments (30-A, 30-B) and stored on two storage media, there is no limitation thereto. The confidential data 30 may be divided into three or more segments, and each of the segments stored on a different storage medium. Moreover there is no particular limitation to the respective numbers of the main storage medium/media and the ancillary storage medium/media.

Moreover, as stated in the first exemplary embodiment, configuration may be made such that only control data relating to the confidential data segments stored on the main storage medium is stored in the register 26. Then, for the confidential data segments stored on the external memory 18, control and acquisition is performed based on the control data for the confidential data segments stored on the main storage medium.

Moreover, obviously appropriate combinations may be made of aspects from each of the above exemplary embodiments.

In each of the above exemplary embodiments, when the capacity of the confidential data segments stored on each of the storage media (the external memory 18 and the memory 28) is stored in the register 26, the capacity itself is stored, however there is no limitation thereto. For example, configuration may be made in which start addresses and end addresses are stored to indicate the storage position of data in each of the storage media.

Moreover, although the control data is stored in the register 26 in each of the above exemplary embodiments, there is no limitation thereto, and the control data may be stored on another storage medium (such as a memory). Note that a register is preferably employed from the perspective of simplicity.

Moreover, although explanation has been given in each of the exemplary embodiments above of cases in which each of the confidential data segments (30-A, 30-B) are stored in advance on the storage media (the external memory 18 and the memory 28) the method of storage to a memory is not particularly limited. Software processing may be applied by the CPU 22 and storage made in a memory.

Moreover, such features as the configurations and operations of for example the confidential data control system 10, the semiconductor device 20, the external memory 18 and the memory 28 explained in the above exemplary embodiments are merely examples thereof, and obviously various modifications are possible according to the circumstances within a range not departing from the spirit of the present invention.

According to the present invention, the advantageous effect is exhibited of enabling confidential data to be safeguarded even in cases of unauthorized access to a single storage unit.

What is claimed is:

1. A semiconductor device comprising a reader unit that synthesizes confidential data by reading each of a plurality of confidential data segments from a respective one of a plurality of storage units based on specific control data, wherein a single item of confidential data is divided into a plurality to give the plurality of confidential data segments and wherein each of the confidential data segments is respectively stored on a different one of the plurality of storage units according to the specific control data.

2. The semiconductor device of claim 1 wherein:
a specific storage unit of the plurality of storage units is designated as a main storage unit, and the specific control data is data relating to storage of a confidential data segment on the main storage unit.

3. The semiconductor device of claim 1 wherein:
the specific control data is at least one type of data selected from the group consisting of data expressing a capacity of the confidential data, data expressing a capacity of the confidential data segment, data expressing a storage position on each of the storage units, and proportions of the confidential data segments stored on each of the plurality of storage units.

4. The semiconductor device of claim 2 wherein:
the specific control data is at least one type of data selected from the group consisting of data expressing a capacity of the confidential data, data expressing a capacity of the confidential data segment, data expressing a storage position on each of the storage units, and proportions of the confidential data segments stored on each of the plurality of storage units.

5. The semiconductor device of claim 1 wherein:
the confidential data segments are data synthesized by combining a plurality of subdivisions of the confidential data, which has been subdivided;
the specific control data is data relating to the subdividing; and
the reader unit synthesizes confidential data by synthesizing using data subdivided from the confidential data segments based on the control data.

6. The semiconductor device of claim 2 wherein:
the confidential data segments are data synthesized by combining a plurality of subdivisions of the confidential data, which has been subdivided;
the specific control data is data relating to the subdividing; and
the reader unit synthesizes confidential data by synthesizing using data subdivided from the confidential data segments based on the control data.

7. The semiconductor device of claim 3 wherein:
the confidential data segments are data synthesized by combining a plurality of subdivisions of the confidential data, which has been subdivided;
the specific control data is data relating to the subdividing; and
the reader unit synthesizes confidential data by synthesizing using data subdivided from the confidential data segments based on the control data.

8. A confidential data control system comprising:
a plurality of storage units storing a single item of confidential data that has been divided into a plurality to give a plurality of confidential data segments that have been respectively stored according to specific control data; and
a reader unit that synthesizes confidential data by, when reading the confidential data, reading the confidential data segments from the respective storage units based on the control data.

9. A confidential data control method comprising:
synthesizing confidential data by reading each of a plurality of confidential data segments from a respective one of a plurality of storage units based on specific control data, wherein a single item of confidential data is divided into a plurality to give the plurality of confidential data segments and wherein each of the confidential data segments is respectively stored on a different one of the plurality of storage units according to the specific control data.

10. A confidential data control method comprising storing a single item of confidential data that has been divided into a plurality to give a plurality of confidential data segments by storing the plurality of confidential data segments respectively on a plurality of storage units according to specific control data.
